(19) United States
(12) Patent Application Publication
(10) Pub. No.: US 2026/0360829 A1
(43) Pub. Date: Nov. 12, 2026

(54) METHOD FOR MANUFACTURING ELECTRODE ASSEMBLY FOR SECONDARY BATTERY AND METHOD FOR MANUFACTURING SECONDARY BATTERY COMPRISING SAME

(71) Applicant: SK ON CO., LTD., Seoul (KR)

(72) Inventors: Chang Mook HWANG, Daejeon (KR); Hyun Ji KIM, Daejeon (KR); Jong Hyeok LEE, Daejeon (KR); Yoon Ji JO, Daejeon (KR)

(21) Appl. No.: 19/477,119

(22) PCT Filed: Apr. 19, 2024
(86) PCT No.: PCT/KR2024/005283

§ 371 Date: Oct. 21, 2025

(30) Foreign Application Priority Data
Apr. 21, 2023 (KR) 10-2023-0052594

(51) Int. Cl. H01M 10/0587; H01M 4/02; H01M 4/04; H01M 4/36

(52) U.S. Cl. CPC H01M 10/0587; H01M 4/0407; H01M 4/366; H01M 2004/021

(57) ABSTRACT

In a method for manufacturing an electrode assembly for a lithium secondary battery according to some embodiments, an electrode current collector is prepared. An upper active material layer is formed on an upper surface of the electrode current collector, and a lower active material layer having a lower density than the upper active material layer is formed on a lower surface of the electrode current collector to form a preliminary electrode. The preliminary electrode is then wound with the lower active material layer disposed on an inner side of the winding to form a wound electrode including an upper wound active material layer and a lower wound active material layer. Accordingly, the density of the active material within the wound electrode assembly may be maintained substantially uniform throughout, thereby improving cycle life properties.

### TECHNICAL FIELD

The present disclosure relates to a method for manufacturing an electrode assembly for a secondary battery and a method for manufacturing a secondary battery including the electrode assembly for a secondary battery. More specifically, the present disclosure relates to a method for manufacturing an electrode assembly for a secondary battery having active material layers formed on both surfaces of a current collector, and a secondary battery including the electrode assembly for a secondary battery.

### BACKGROUND ART

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as electric cars.

Examples of the secondary battery may include a lithium secondary battery, a nickel-cadmium battery, and a nickel-hydrogen battery. Among these, lithium secondary batteries are actively being researched and developed due to their high operating voltage, high energy density per unit weight, and advantages in charging speed and weight reduction.

For example, the lithium secondary battery may include: an electrode assembly including a cathode, an anode, and a separation membrane (separator); and an electrolyte in which the electrode assembly is impregnated. The lithium secondary battery may further include, for example, a pouch-type outer case in which the electrode assembly and the electrolyte are accommodated.

The electrode assembly may have, for example, a jelly-roll shape in which the cathode and the anode are wound with the separation membrane interposed therebetween.

However, in the jelly-roll type electrode assembly, the density of the active material may be uneven due to winding, resulting in non-uniformity in energy density and cycle life properties.

### SUMMARY OF INVENTION

### Problems to be Solved by Invention

An object of the present disclosure is to provide a method for manufacturing an electrode assembly for a secondary battery with improved cycle life properties and energy density.

Another object of the present disclosure is to provide a secondary battery including the electrode assembly for a secondary battery.

### Means for Solving Problems

In a method for manufacturing an electrode assembly for a lithium secondary battery according to some embodiments, an electrode current collector may be prepared. An upper active material layer may be formed on an upper surface of the electrode current collector, and a lower active material layer having a lower density than the upper active material layer may be formed on a lower surface of the electrode current collector to form a preliminary electrode. The preliminary electrode may then be wound with the lower active material layer disposed on an inner side of the winding to form a wound electrode including an upper wound active material layer and a lower wound active material layer.

In some embodiments, the density of the upper wound active material layer may be lower than the density of the upper active material layer, and the density of the lower wound active material layer may be greater than the density of the lower active material layer.

In some embodiments, the density difference between the upper wound active material layer and the lower wound active material layer may be lower than the density difference between the upper active material layer and the lower active material layer.

In some embodiments, the density difference between the upper wound active material layer and the lower wound active material layer may be 0.1 g/cm³ or less.

In some embodiments, forming the upper active material layer and the lower active material layer may include coating an upper slurry and a lower slurry including a solvent and an active material, respectively, on the upper surface and the lower surface of the electrode current collector, and the solvent used in the upper slurry may be different from the solvent used in the lower slurry.

In some embodiments, the step of forming the preliminary electrode may include forming at least one of the upper active material layer and the lower active material layer in a multi-layer structure having different densities.

In some embodiments, forming the multi-layer structure may include: forming a first active material layer on a surface of the electrode current collector; and forming a second active material layer on the first active material layer, the second active material layer being spaced apart from the electrode current collector with the first active material layer interposed therebetween, and having a different density from the first active material layer.

In some embodiments, forming the first active material layer may include applying a first slurry including a first solvent and a first active material, and forming the second active material layer may include applying a second slurry including a second solvent different from the first solvent and a second active material to the first active material layer.

In some embodiments, the second solvent may include a solvent that is immiscible with the first solvent.

In some embodiments, the upper active material layer may include the first active material layer and the second active material layer, and the density of the second active material layer may be greater than the density of the first active material layer.

In some embodiments, the lower active material layer may include the first active material layer and the second active material layer, and the density of the first active material layer may be greater than the density of the second active material layer.

In some embodiments, the first active material and the second active material may be the same active material.

In some embodiments, the first solvent and the second solvent may have different solubilities for the active material.

In some embodiments, the method may further include arranging the preliminary electrodes on a first surface and a second surface opposite to each other of a separation membrane, respectively, and the separation membrane may be wound together with the preliminary electrode.

In a method for manufacturing a secondary battery according to exemplary embodiments, the electrode assembly manufactured according to the method for manufacturing an electrode assembly for a secondary battery may be prepared. The electrode assembly may be accommodated in a case.

### Advantageous Effects

According to some embodiments, the active material loading amount and density of the lower active material layer, disposed on the inner side during a winding operation, may be relatively reduced. Therefore, the densities of the wound active material layers disposed on the outer and inner sides of the winding may be substantially uniformly controlled, preventing electrode cracks and delamination due to variations in active material distribution within the jelly-roll, thereby achieving uniform energy density and cycle life properties.

In some embodiments, the active material layer includes a first active material layer and a second active material layer sequentially formed on the electrode current collector, wherein the density of the active material layer disposed on the inner side of the first active material layer and the second active material layer may be lower than that of the active material layer disposed on the outer side. By utilizing a multi-layer structure, the density difference in the active material layers of the above-described preliminary electrode may be more easily implemented. Furthermore, by using different solvents in the slurries for forming the first active material layer and the second active material layer, mixing between the active materials and density disturbance between the first active material layer and the second active material layer may be prevented.

The method for manufacturing an electrode assembly for a secondary battery of the present disclosure and the secondary battery manufactured according to the method for manufacturing the secondary battery may be widely applied in green technology fields, such as electric vehicles, battery charging stations, as well as solar power generation, wind power generation, and the like, which use the batteries. The anode active material for a lithium secondary battery of the present disclosure, the method for manufacturing the same, and the lithium secondary battery including the same may be used in eco-friendly electric vehicles, hybrid vehicles, and the like, which are aimed at mitigating climate change by reducing air pollution and greenhouse gas emissions.

### BRIEF DESCRIPTION OF DRAWINGS

FIGS. 1 and 2 are views for describing a method for manufacturing an electrode assembly for a secondary battery according to some embodiments.

FIGS. 3 and 4 are schematic cross-sectional views illustrating a preliminary electrode according to some embodiments.

FIG. 5 is a schematic plan view illustrating a secondary battery according to some embodiments.

### MODE FOR CARRYING OUT INVENTION

Embodiments of the present disclosure provide a method for manufacturing an electrode assembly for a secondary battery, which includes winding a preliminary electrode having a density variation between active material layers disposed on both surfaces of an electrode current collector. In addition, a method for manufacturing a secondary battery including the electrode assembly for a secondary battery is provided.

Hereinafter, the embodiments of the present disclosure will be described in more detail with reference to the accompanying drawings. However, the drawings attached to the present disclosure are merely illustrative of some embodiments of the present disclosure to aid in understanding the technical spirit of the invention together with the foregoing description. Therefore, the present disclosure should not be construed as being limited to the matters illustrated in the drawings.

As used herein, the terms “upper portion,” “lower portion,” “upper surface,” “lower surface,” and the like, are used in a relative sense to distinguish the positions of components, and do not specify absolute positions.

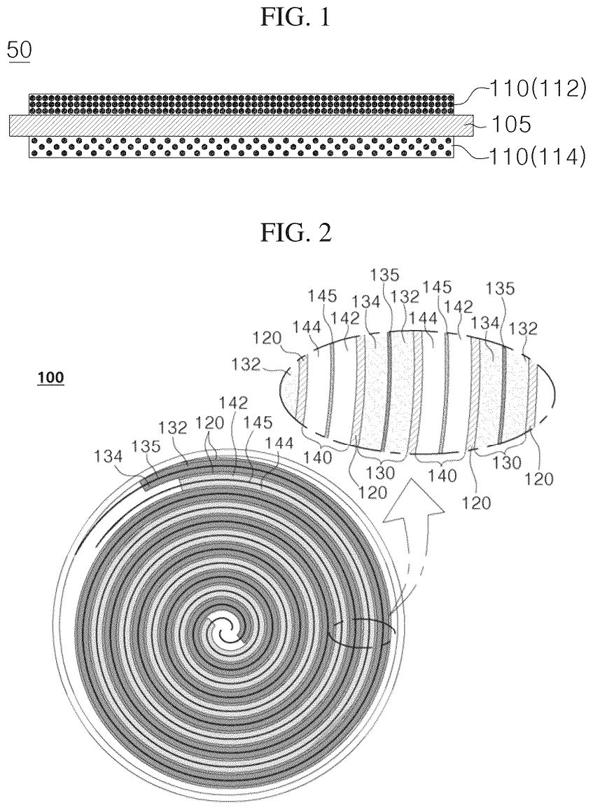

FIGS. 1 and 2 are views for describing a method of manufacturing an electrode assembly for a secondary battery according to some embodiments.

Referring to FIG. 1, an active material layer 110 may be formed on an electrode current collector 105 to form a preliminary electrode 50. The active material layer 110 may include an active material that provides charge/discharge activity to the electrode of the secondary battery. For example, the active material may be dispersed in the form of particles within the active material layer 110, as indicated by the black dots in FIG. 1.

According to some embodiments, an upper active material layer 112 may be formed on an upper surface of the electrode current collector 105, and a lower active material layer 114 having a lower density than the upper active material layer 112 may be formed on a lower surface of the electrode current collector 105.

The active material layer 110 may be formed by coating a slurry including the active material on the electrode current collector 105, followed by drying and roll-pressing. For example, the slurry may be prepared by mixing the active material with a binder, a conductive material and/or a dispersant in a solvent.

In some embodiments, the upper active material layer 112 may be formed by coating an upper slurry including the active material on the upper surface of the electrode current collector 105, followed by drying and roll-pressing. In addition, the lower active material layer 114 may be formed by coating a lower slurry including the active material on the lower surface of the electrode current collector 105, followed by drying and roll-pressing.

A polar aprotic solvent may include, for example, N-methyl-2-pyrrolidone (NMP), dimethylformamide (DMF), dimethyl sulfoxide (DMSO), acetonitrile, butylene carbonate, propylene carbonate (PC), dimethyl carbonate (DMC), diethyl carbonate (DEC), ethyl methyl carbonate (EMC), methyl propyl carbonate (MPC), ethylene carbonate (EC), ethyl bromide, tetrahydrofuran (THF), acetone or the like.

A polar protic solvent may include, for example, deionized water, distilled water, ethanol, isopropanol, methanol, n-propanol, t-butanol or the like.

A non-polar solvent may include, for example, hexane, heptane, carbon tetrachloride, benzene, toluene, ethylbenzene, xylene, 1,4-dioxane or the like. These may be used alone or in combination of two or more thereof.

In some embodiments, the solvent used in the upper slurry may be different from the solvent used in the lower slurry. For example, the polarity of the solvent used in the upper slurry may be different from that of the solvent used in the lower slurry.

In an embodiment, the solubility of the active material in the solvent used in the upper slurry may be greater than that of the active material in the solvent used in the lower slurry. In this case, the amount of active material included in the upper slurry may be greater than that included in the lower slurry. Accordingly, the density of the upper active material layer 112 may be greater than that of the lower active material layer 114.

In some embodiments, the preliminary electrode 50 may be a preliminary electrode for a cathode.

For example, the density of the upper active material layer of the preliminary electrode for a cathode may be 2.85 to 3.75 g/cm³, or 3.0 to 3.7 g/cm³. The density of the lower active material layer of the preliminary electrode for a cathode may be 2.75 to 3.65 g/cm³, or 2.8 to 3.4 g/cm³. Within these ranges, the active material layers of the preliminary electrode for a cathode may be densely roll-pressed, thereby preventing the active material layers of the preliminary electrode for a cathode from separating from each other.

When the preliminary electrode 50 is a preliminary electrode for a cathode, the active material included in the preliminary electrode 50 may include a compound capable of reversibly intercalating and deintercalating lithium ions. The active material may include lithium-transition metal composite oxide particles. For example, the lithium-transition metal composite oxide particles may include nickel (Ni), and may further include at least one of cobalt (Co) and manganese (Mn).

For example, the lithium-transition metal composite oxide particles may be represented by Formula 1 below.

LiₓNi_{1-y}M_{y}O_{2+z} [Formula 1]

In Formula 1, x may be in the range of 0.95x≤1.1, y may be in the range of 0≤y≤0.7, and z may be in the range of −0.1≤z≤0.1. M may represent one or more elements selected from Na, Mg, Ca, Y, Ti, Zr, Hf, V, Nb, Ta, Cr, Mo, W, Mn, Co, Fe, Cu, Ag, Zn, B, Al, Ga, C, Si, Sn and Sr.

A cathode binder may include, for example, an organic binder such as vinylidene fluoride-hexafluoropropylene copolymer (PVDF-co-HFP), polyvinylidene fluoride (PVDF), polyacrylonitrile, polymethyl methacrylate, and the like, or an aqueous binder such as styrene-butadiene rubber (SBR). The cathode binder may be included together with a thickener such as carboxymethyl cellulose (CMC).

For example, a PVDF-based binder may be used as the cathode binder. In this case, the amount of the binder for forming the cathode active material layer may be reduced and the amount of the cathode active material may be relatively increased, thereby improving the output and capacity of the secondary battery 200.

The cathode current collector 135 may include, for example, stainless steel, nickel, aluminum, titanium, copper, or an alloy thereof. For example, the cathode current collector 135 may include aluminum or an aluminum alloy.

A cathode conductive material may be included to promote electron migration between the active material particles. For example, the cathode conductive material may include carbon-based conductive materials such as graphite, carbon black, graphene, or carbon nanotubes, and/or metal-based conductive materials, including perovskite materials, such as tin, tin oxide, titanium oxide, LaSrCoO₃, and LaSrMnO₃, and the like.

In some embodiments, the preliminary electrode 50 may be a preliminary electrode for an anode.

For example, the density of the upper active material layer of the preliminary electrode for an anode may be 1.25 to 1.8 g/cm³, or 1.5 to 1.7 g/cm³. The density of the lower active material layer of the preliminary electrode for an anode may be 1.15 to 1.7 g/cm³, or 1.4 to 1.6 g/cm³. Within these ranges, the active material layers of the preliminary electrode for an anode may be densely roll-pressed, thereby preventing the active material layers of the preliminary electrode for an anode from separating from each other.

In some embodiments, the preliminary electrode 50 may be a preliminary electrode for an anode. In this case, the active material included in the preliminary electrode 50 may include a compound capable of adsorbing and desorbing lithium ions. For example, the active material may include carbon-based materials such as crystalline carbon, amorphous carbon, carbon composites, and carbon fibers, a lithium alloy, a silicon (Si)-based compound, or tin.

The amorphous carbon may include, for example, hard carbon, coke, or mesophase pitch-based carbon fiber (MPCF). The crystalline carbon may include, for example, graphitic carbon such as natural graphite, artificial graphite, coke, or graphitized MCMB. The elements included in the lithium alloy may include, for example, aluminum, zinc, bismuth, cadmium, antimony, silicon, lead, tin, gallium, indium or the like. The silicon-based compound may include, for example, a silicon-carbon composite oxide, such as silicon oxide (SiOₓ) or silicon carbide (SiC).

An anode binder may include, for example, an aqueous binder such as styrene-butadiene rubber (SBR) to ensure compatibility with a carbon-based active material. The anode binder may be included together with a thickener such as carboxymethyl cellulose (CMC).

The anode current collector 145 may include gold, stainless steel, nickel, aluminum, titanium, copper, or an alloy thereof. For example, the anode current collector 145 may include copper or a copper alloy.

The anode conductive material may include, for example, a carbon-based conductive material such as carbon nanotubes, carbon black, or Super P.

Referring to FIG. 2, the preliminary electrode 50 may be wound to form an electrode assembly 100 including a wound electrode.

According to some embodiments, the preliminary electrode 50 may be wound into a jelly-roll shape, with the upper active material layer 112 of the electrode current collector 105 disposed on an outer side of the winding and the lower active material layer 114 disposed on an inner side of the winding. Accordingly, a wound electrode including the upper wound active material layer and the lower wound active material layer may be formed.

In some embodiments, the upper wound active material layer may have a density lower than that of the upper active material layer 112. The upper active material layer 112 may be stretched under winding tension. Accordingly, the active material density may decrease as a tensile force is applied to the upper active material layer 112 having a relatively high density.

In some embodiments, the lower wound active material layer may have a density greater than that of the lower active material layer 114. The lower active material layer 114 may be compressed under winding compression. Accordingly, the density of the active material may increase as a compressive force is applied to the lower active material layer 114 having a relatively low density.

As described above, the density of the upper wound active material layer may decrease, and the density of the lower wound active material layer may increase.

In some embodiments, the density difference between the upper wound active material layer and the lower wound active material layer may be lower than the density difference between the upper active material layer 112 and the lower active material layer 114. Accordingly, non-uniformity in energy density and cycle life properties due to variations in the distribution of active material between the upper wound active material layer and the lower wound active material layer may be suppressed.

In an embodiment, the density difference between the upper wound active material layer and the lower wound active material layer may be 0.1 g/cm³ or less, or 0.05 g/cm³ or less. Within this range, delamination and cracks of the active material layer due to differences in electrode expansion caused by variations in the distribution of active material in the electrode assembly 100 may be suppressed.

The wound electrode may include a cathode 130 and an anode 140. In some embodiments, a separation membrane 120 may be placed between the cathode 130 and the anode 140, and the cathode 130 and the anode 140 may be wound together with the separation membrane 120.

The cathode 130 may include a cathode current collector 135, an upper cathode active material layer 132, and a lower cathode active material layer 134 with the cathode current collector 135 interposed therebetween. For example, the lower cathode active material layer 134 may be disposed on the inner side of the winding, and the upper cathode active material layer 132 may be disposed on the outer side of the winding.

The density of the upper cathode active material layer 132 may be 2.8 to 3.7 g/cm³, or 2.9 to 3.6 g/cm³. The density of the lower cathode active material layer 134 may be 2.8 to 3.7 g/cm³, or 2.9 to 3.5 g/cm³. Within these ranges, cracks in the cathode active material layers 132 and 134 may be prevented, and the energy density of the secondary battery may be improved.

The anode 140 may include an anode current collector 145, and an upper anode active material layer 142 and a lower anode active material layer 144 with the anode current collector 145 interposed therebetween. For example, the lower anode active material layer 144 may be disposed on the inner side of the winding, and the upper anode active material layer 142 may be disposed on the outer side of the winding.

The density of the upper anode active material layer 142 may be 1.2 to 1.75 g/cm³, or 1.45 to 1.65 g/cm³. The density of the lower anode active material layer 144 may be 1.2 to 1.75 g/cm³, or 1.45 to 1.65 g/cm³. Within these ranges, cracks in the anode active material layers (142, 144) may be prevented, and the energy density of the secondary battery may be improved.

The separation membrane 120 may include a porous polymer film made of a polyolefin polymer such as an ethylene homopolymer, propylene homopolymer, ethylene/butene copolymer, ethylene/hexene copolymer, ethylene/methacrylate copolymer. The separation membrane 120 may include a nonwoven fabric made of glass fibers having a high melting point, polyethylene terephthalate fibers, and the like.

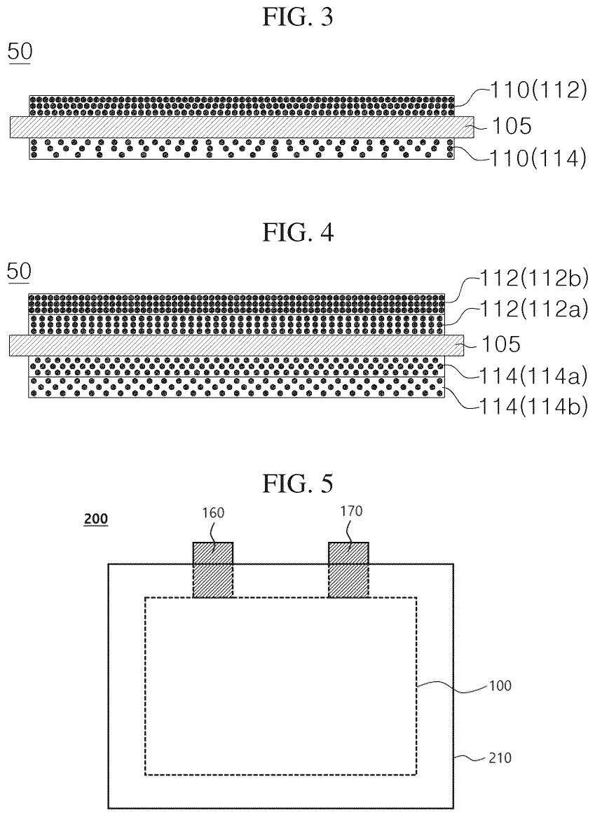

FIGS. 3 and 4 are schematic cross-sectional views illustrating a preliminary electrode according to some embodiments. Detailed descriptions of structures and processes that are substantially the same as or similar to those described with reference to FIGS. 1 and 2 are omitted.

Referring to FIG. 3, the density may also gradually increase within the active material layer 110.

In an embodiment, the active material density may gradually increase from lower portions to upper portions of the upper active material layer 112 and the lower active material layer 114. Accordingly, uniform density may be achieved within the upper wound active material layer and the lower wound active material layer of the wound electrode.

Referring to FIG. 4, a first active material layer may be formed on the electrode current collector 105, and a second active material layer having a different density from the first active material layer may be formed on the first active material layer, thereby forming the active material layer 110 having a multi-layer structure with different densities.

For example, the second active material layer may be formed spaced apart from the electrode current collector 105 with the first active material layer interposed therebetween.

According to some embodiments, at least one of the upper active material layer 112 and the lower active material layer 114 may be formed as the active material layer 110 having a multi-layer structure with different densities.

In some embodiments, the upper active material layer 112 may include an upper first active material layer 112a and an upper second active material layer 112b, wherein the density of the upper second active material layer 112b may be greater than that of the upper first active material layer 112a.

In an embodiment, the upper first active material layer 112a may be the upper first active material layer of the preliminary electrode for a cathode, and the upper second active material layer 112b may be the upper second active material layer of the preliminary electrode for a cathode.

In this case, the density of the upper first active material layer of the preliminary electrode for a cathode may be 2.85 to 3.75 g/cm³, or 3.0 to 3.7 g/cm³. The density of the upper second active material layer of the preliminary electrode for a cathode may be 2.9 to 3.75 g/cm³, or 3.1 to 3.7 g/cm³. Within these ranges, cracks in the active material during the winding process may be prevented.

In an embodiment, the upper first active material layer 112a may be the upper first active material layer of the preliminary electrode for an anode, and the upper second active material layer 112b may be the upper second active material layer of the preliminary electrode for an anode.

In this case, the density of the upper first active material layer of the preliminary electrode for an anode may be 1.25 to 1.8 g/cm³, or 1.5 to 1.7 g/cm³. The density of the upper second active material layer of the preliminary electrode for an anode may be 1.3 to 1.8 g/cm³, or 1.6 to 1.8 g/cm³. Within these ranges, cracks in the active material during the winding process may be prevented.

In an embodiment, the density difference between the upper first active material layer 112a and the upper second active material layer 112b may be 0.03 to 0.2 g/cm³, or 0.05 to 0.1 g/cm³. Within this range, separation of the upper first active material layer 112a from the upper second active material layer 112b due to density difference may be prevented.

In some embodiments, the lower active material layer 114 may include a lower first active material layer 114a and a lower second active material layer 114b, wherein the density of the lower first active material layer 114a may be greater than that of the lower second active material layer 114b.

In an embodiment, the lower first active material layer 114a may be the lower first active material layer of the preliminary electrode for a cathode, and the lower second active material layer 114b may be the lower second active material layer of the preliminary electrode for a cathode.

In this case, the density of the lower first active material layer of the preliminary electrode for a cathode may be 2.75 to 3.65 g/cm³, or 2.8 to 3.4 g/cm³. The density of the lower second active material layer of the preliminary electrode for a cathode may be 2.75 to 3.55 g/cm³, or 2.8 to 3.3 g/cm³. Within these ranges, cracks in the active material during the winding process may be prevented.

In an embodiment, the lower first active material layer 114a may be the lower first active material layer of the preliminary electrode for an anode, and the lower second active material layer 114b may be the lower second active material layer of the preliminary electrode for an anode.

In this case, the density of the lower first active material layer of the preliminary electrode for an anode may be 1.2 to 1.75 g/cm³, or 1.45 to 1.65 g/cm³. The density of the lower second active material layer of the preliminary electrode for an anode may be 1.2 to 1.65 g/cm³, or 1.45 to 1.55 g/cm³. Within these ranges, cracks in the active material during the winding process may be prevented.

In an embodiment, the density difference between the lower first active material layer 114a and the lower second active material layer 114b may be 0.03 to 0.2 g/cm³, or 0.05 to 0.1 g/cm³. Within this range, separation of the lower first active material layer 114a from the lower second active material layer 114b due to density difference may be prevented.

In some embodiments, the first active material layer may be formed by coating a first slurry including an active material on the electrode current collector 105, followed by drying and roll-pressing. For example, the first slurry may be prepared by mixing the active material with a binder, a conductive material and/or a dispersant in a first solvent. In some embodiments, the second active material layer may be formed by coating a

second slurry including an active material on the first active material layer, followed by drying and roll-pressing. For example, the second slurry may be prepared by mixing the active material with a binder, a conductive material and/or a dispersant in a second solvent.

In one embodiment, the active material included in the first slurry may be the same active material as the active material included in the second slurry.

In some embodiments, the first solvent may be a different solvent from the second solvent. For example, the first solvent and the second solvent may have different solubilities for the active material.

In an embodiment, the second solvent may include a solvent that is immiscible with the first solvent.

For example, the first solvent and the second solvent may have different polarities.

Accordingly, the second slurry may be phase-separated on the first slurry phase due to the difference in polarity between the first solvent and the second solvent.

For example, the density of the first solvent may be greater than that of the second solvent. Accordingly, the second slurry may be phase-separated on the first slurry phase due to the difference in density between the first solvent and the second solvent. In some embodiments, the first slurry may include an upper first slurry for forming

the upper first active material layer 112a and a lower first slurry for forming the lower first active material layer 114a. The second slurry may include an upper second slurry for forming the upper second active material layer 112b and a lower second slurry for forming the lower second active material layer 114b.

In an embodiment, the loading amount of the upper first slurry may be greater than that of the lower second slurry. For example, the difference in loading amount between the upper first slurry and the lower second slurry may be 0.07 to 1.3 mg/cm², or 0.1 to 1.0 mg/cm².

In an embodiment, the loading amount of the upper second slurry may be greater than that of the lower first slurry. For example, the difference in loading amount between the upper second slurry and the lower first slurry may be 0.07 to 1.3 mg/cm², or 0.1 to 1.0 mg/cm².

In some embodiments, the first solvent may include an upper first solvent included in the upper first slurry and a lower first solvent included in the lower first slurry. The second solvent may include an upper second solvent included in the upper second slurry and a lower second solvent included in the lower second slurry.

In an embodiment, the solubility of the active material in the upper first solvent may be lower than that of the active material in the upper second solvent. In this case, the amount of the active material included in the upper first slurry may be lower than that of the active material included in the upper second slurry. Accordingly, the density of the upper first active material layer 112a may be lower than that of the upper second active material layer 112b.

In an embodiment, the solubility of the active material in the lower first solvent may be greater than the solubility of the active material in the lower second solvent. In this case, the amount of the active material included in the lower first slurry may be greater than the amount of the active material included in the lower second slurry. Accordingly, the density of the lower first active material layer 114a may be greater than that of the lower second active material layer 114b.

FIG. 5 is a schematic plan view illustrating a secondary battery 200 according to some embodiments.

Referring to FIG. 5, the secondary battery 200 may be manufactured by preparing the electrode assembly 100 and accommodating the electrode assembly 100 in an outer case 210.

The electrode assembly 100 may be accommodated in the outer case 210 together with an electrolyte, thereby defining the secondary battery 200. According to some embodiments, a non-aqueous electrolyte may be used as the electrolyte.

The non-aqueous electrolyte may include a lithium salt of an electrolyte and an organic solvent. The lithium salt is represented by, for example, Li⁺X⁻, and as an anion (X) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃, (CF₃)₄PF₂⁻, (CF₃)₅PF⁻, (CF₃)₆P⁻, CF₃SO₃⁻, CF₃ CF₂SO₃⁻, (CF₃SO₂)₂N⁻, (FSO₂)₂N⁻; CF₃ CF₂(CF₃)₂ CO⁻, (CF₃SO₂)₂ CH⁻, (SF₅)₃ C⁻, (CF₃SO₂)₃ C⁻, CF₃ (CF₂)₇SO₃⁻, CF₃ CO₂⁻, CH₃ CO₂⁻, SCN⁻ and (CF₃ CF₂SO₂)₂N⁻, and the like may be exemplified.

As the organic solvent, for example, propylene carbonate (PC), ethylene carbonate (EC), diethyl carbonate (DEC), dimethyl carbonate (DMC), ethyl methyl carbonate (EMC), methyl propyl carbonate, dipropyl carbonate, dimethylsulfuroxide, acetonitrile, dimethoxyethane, diethoxyethane, vinylene carbonate, sulfolane, gamma-butyrolactone, propylene sulfite and tetrahydrofuran, and the like may be used. These may be used alone or in combination of two or more thereof.

As shown in FIG. 5, electrode tabs may protrude from the electrode current collectors, which belong to each electrode cell, and may extend to one side of the outer case 210. The electrode tabs may be fused together with the one side of the outer case 210 and connected to electrode leads 160 and 170 that extend or are exposed to the outside of the outer case 210.

The lithium secondary battery 200 may be manufactured, for example, in a cylindrical shape using a can, a prismatic shape, a pouch shape or a coin shape.

Hereinafter, experimental examples including specific examples and comparative examples are presented to aid in the understanding of the present invention. However, these examples are provided merely for illustrative purposes of the present invention and are not intended to limit the scope of the appended claims. It will be apparent to those skilled in the art that various changes and modifications may be made within the scope and spirit thereof, and such changes and modifications are to be regarded as falling within the scope of the appended claims.

### EXAMPLES AND COMPARATIVE EXAMPLES

### Example 1

### 1) Preparation of Anode

A lower anode slurry was prepared by mixing 24% by weight (“wt %”) of natural graphite, 70 wt % of artificial graphite, 1 wt % of carboxymethyl cellulose (CMC), 4 wt % of styrene-butadiene rubber, and 1 wt % of carbon nanotubes (CNTs) as a conductive material in a solvent. The lower anode slurry was applied to a first surface of a copper (Cu) foil current collector, and then dried and roll-pressed to form a lower anode active material layer having an active material density of 1.55 g/cm³. Distilled water was used as the solvent.

An upper anode slurry was prepared by mixing 24 wt % of natural graphite, 70 wt % of artificial graphite, 1 wt % of carboxymethyl cellulose (CMC), 4 wt % of styrene-butadiene rubber, and 1 wt % of carbon nanotubes (CNTs) as a conductive material in a solvent. The upper anode slurry was applied to a second surface of the copper (Cu) foil current collector having the lower anode active material layer formed thereon, and then dried and roll-pressed to form an upper anode active material layer having an active material density of 1.65 g/cm³, thereby fabricating an anode for a secondary battery. Propylene carbonate (PC) was used as the solvent.

### 2) Manufacture of Cylindrical Cell

Lithium foil was used as a counter electrode, and a polyethylene (PE) separation membrane was interposed between the anode and the counter electrode. The electrode assembly was then wound so that the outermost portion had a curvature of 2 and the lower anode active material layer was disposed on the inner side of the winding. An electrolyte was then injected to manufacture a cylindrical cell.

### Example 2

### 1) Preparation of Anode

A lower first anode slurry was prepared by mixing 24 wt % of natural graphite, 70 wt % of artificial graphite, 1 wt % of carboxymethyl cellulose (CMC), 4 wt % of styrene-butadiene rubber, and 1 wt % of carbon nanotubes (CNTs) as a conductive material in a lower first solvent. The lower first anode slurry was applied to a first surface of a copper (Cu) foil current collector, and then dried and roll-pressed to form a lower first anode active material layer having an active material density of 1.58 g/cm³. N-methyl-2-pyrrolidone (NMP) was used as the lower first solvent.

A lower second anode slurry was prepared by mixing 24 wt % of natural graphite, 70 wt % of artificial graphite, 1 wt % of carboxymethyl cellulose (CMC), 4 wt % of styrene-butadiene rubber (SBR), and 1 wt % of carbon nanotubes (CNTs) as a conductive material in a lower second solvent. The lower second anode slurry was applied to the lower first anode active material layer, and then dried and roll-pressed to form a lower second anode active material layer having an active material density of 1.5 g/cm³. Ethanol was used as the lower second solvent.

An upper first anode slurry was prepared by mixing 24 wt % of natural graphite, 70 wt % of artificial graphite, 1 wt % of carboxymethyl cellulose (CMC), 4 wt % of styrene-butadiene rubber, and 1 wt % of carbon nanotubes (CNTs) as a conductive material in an upper first solvent. The upper first anode slurry was applied to a second surface of the copper (Cu) foil current collector having the lower first anode active material layer and the lower second anode active material layer formed thereon, and then dried and roll-pressed to form an upper first anode active material layer having an active material density of 1.62 g/cm³. Propylene carbonate (PC) was used as the upper first solvent.

An upper second anode slurry was prepared by mixing 24 wt % of natural graphite, 70 wt % of artificial graphite, 1 wt % of carboxymethyl cellulose (CMC), 4 wt % of styrene-butadiene rubber, and 1 wt % of carbon nanotubes (CNTs) as a conductive material in an upper second solvent. The upper second anode slurry was applied to the upper first anode active material layer, and then dried and roll-pressed to form an upper second anode active material layer having an active material density of 1.7 g/cm³, thereby fabricating an anode for a secondary battery. Distilled water was used as the upper second solvent.

### 2) Manufacture of Cylindrical Cell

Lithium foil was used as a counter electrode, and a polyethylene (PE) separation membrane was interposed between the anode and the counter electrode. The electrode assembly was then wound so that the outermost portion had a curvature of 2, and the lower first anode active material layer and the lower second anode active material layer were disposed on the inner side of the winding. Thereafter, an electrolyte was injected to manufacture a cylindrical cell.

### Example 3

A cylindrical cell was manufactured in the same manner as in Example 2, except that the anode slurry was applied, dried, and roll-pressed such that the active material density of the lower first anode active material layer was 1.6 g/cm³, the active material density of the upper first anode active material layer was 1.65 g/cm³, the active material density of the lower second anode active material layer was 1.55 g/cm³, and the active material density of the upper second anode active material layer was 1.7 g/cm³.

### Example 4

A cylindrical cell was manufactured in the same manner as in Example 2, except that the anode slurry was applied, dried, and roll-pressed such that the active material density of the lower first anode active material layer was 1.7 g/cm³, the active material density of the upper first anode active material layer was 1.7 g/cm³, the active material density of the lower second anode active material layer was 1.6 g/cm³, and the active material density of the upper second anode active material layer was 1.8 g/cm³.

### Example 5

A cylindrical cell was manufactured in the same manner as in Example 2, except that the outermost portion was set to have a curvature of 1.

### Example 6

A cylindrical cell was manufactured in the same manner as in Example 2, except that the outermost portion was set to have a curvature of 3.

### Example 7

A cylindrical cell was manufactured in the same manner as in Example 2, except that the active materials mixed in the upper first slurry and upper second slurry were 23 wt % of natural graphite, 68 wt % of artificial graphite, and 3 wt % of SiC.

### Comparative Example 1

### 1) Preparation of Anode

An anode slurry was prepared by mixing 24 wt % of natural graphite, 70 wt % of artificial graphite, 1 wt % of carboxymethyl cellulose (CMC), 4 wt % of styrene-butadiene rubber, and 1 wt % of carbon nanotubes (CNTs) as a conductive material in distilled water. The anode slurry was applied to a copper (Cu) foil current collector, and then dried and roll-pressed to form an anode active material layer having an active material density of 1.6 g/cm³, thereby fabricating an anode for a secondary battery.

### 2) Manufacture of Cylindrical Cell

Lithium foil was used as a counter electrode, and a polyethylene (PE) separation membrane was interposed between the anode and the counter electrode. Thereafter, the electrode assembly was wound so that the outermost portion had a curvature of 2, and an electrolyte was then injected to manufacture a cylindrical cell.

### Comparative Example 2

A cylindrical cell was manufactured in the same manner as in Comparative Example 1, except that the anode slurry was applied, dried, and roll-pressed such that the anode active material layer had an active material density of 1.7 g/cm³.

### Comparative Example 3

A cylindrical cell was manufactured in the same manner as in Comparative Example 1, except that the anode slurry was applied, dried, and roll-pressed such that the anode active material layer had an active material density of 1.5 g/cm³.

### Comparative Example 4

5 A cylindrical cell was manufactured in the same manner as in Comparative Example 1, except that the active materials mixed into the anode slurry were 23 wt % of natural graphite, 68 wt % of artificial graphite, and 3 wt % of SiC.

The active materials used in the examples, the curvature of the outermost portion, and the active material density before winding are shown in Table 1 below.

TABLE 1

| | | | Average active material density (g/cm³) | | | |
|---|---|---|---|---|---|---|
| | | | Lower | Upper | Lower | Upper |
| | | | (first) | (first) | second | second |
| | Anode | | active | active | active | active |
| | active | Curva- | material | material | material | material |
| | material | ture | layer | layer | layer | layer |
| Example | Natural | 2 | 1.55 | 1.65 | — | — |
| 1 | graphite and | | | | | |
| | artificial | | | | | |
| | graphite | | | | | |
| Example | Natural | 2 | 1.58 | 1.62 | 1.5 | 1.7 |
| 2 | graphite and | | | | | |
| | artificial | | | | | |
| | graphite | | | | | |
| Example | Natural | 2 | 1.6 | 1.65 | 1.55 | 1.7 |
| 3 | graphite and | | | | | |
| | artificial | | | | | |
| | graphite | | | | | |
| Example | Natural | 2 | 1.7 | 1.7 | 1.6 | 1.8 |
| 4 | graphite and | | | | | |
| | artificial | | | | | |
| | graphite | | | | | |
| Example | Natural | 1 | 1.58 | 1.62 | 1.5 | 1.7 |
| 5 | graphite and | | | | | |
| | artificial | | | | | |
| | graphite | | | | | |
| Example | Natural | 3 | 1.58 | 1.62 | 1.5 | 1.7 |
| 6 | graphite and | | | | | |
| | artificial | | | | | |
| | graphite | | | | | |
| Example | Natural | 2 | 1.55 | 1.55 | 1.5 | 1.6 |
| 7 | graphite, | | | | | |
| | artificial | | | | | |
| | graphite, and | | | | | |
| | carbide | | | | | |
| | (SiC) | | | | | |

### Experimental Example

(1) Measurement of Active Material Density of the Anode Active Material Layers after Winding

After winding, the thickness, length, and width of the electrode were measured using a micrometer to calculate the volume of the wound cylindrical cell, and the active material weight was used to determine the active material density of the active material layers.

### (2) Measurement of Energy Density

The battery cells according to the examples and comparative examples were charged once (CC-CV 1.0 C, 4.2V, 0.05 C cut-off) and discharged once (CC 1.0 C, 2.7V cut-off). The measured capacity was converted into energy density.

### (3) Measurement of Cycle Life Properties

The battery cells according to the examples and comparative examples were repeatedly charged (CC-CV 1.0 C, 4.2V cut-off) and discharged (1.0 C, 2.7V cut-off). The number of cycles was measured until the discharge capacity reached 60% or less relative to the initial discharge capacity.

The evaluation results are shown in Table 2 below.

TABLE 2

| | Average active material density (g/cm³) | | | | | |
|---|---|---|---|---|---|---|
| | Lower | Upper | Lower | Upper | | |
| | (first) | (first) | second | second | | Cycle |
| | active | active | active | active | Energy | life |
| | material | material | material | material | density | properties |
| | layer | layer | layer | layer | (Wh/L) | (cycles) |
| Example 1 | 1.6 | 1.6 | — | — | 500 | 800 |
| Example 2 | 1.6 | 1.6 | 1.6 | 1.6 | 500 | 1,000 |
| Example 3 | 1.61 | 1.62 | 1.6 | 1.63 | 530 | 1,000 |
| Example 4 | 1.72 | 1.65 | 1.7 | 1.7 | 550 | 800 |
| Example 5 | 1.59 | 1.59 | 1.57 | 1.61 | 500 | 900 |
| Example 6 | 1.61 | 1.61 | 1.59 | 1.63 | 500 | 900 |
| Example 7 | 1.6 | 1.5 | 1.6 | 1.5 | 550 | 800 |
| Comparati | 1.66 | 1.545 | — | — | 500 | 500 |
| Example 1 | | | | | | |
| Comparative | 1.76 | 1.645 | — | — | 550 | 300 |
| Example 2 | | | | | | |
| Comparative | 1.555 | 1.44 | — | — | 450 | 700 |
| Example 3 | | | | | | |
| Comparative | 1.66 | 1.545 | — | — | 550 | 300 |
| Example 4 | | | | | | |

Referring to Table 2, in examples where the density of the active material layers of the preliminary electrode increased from the center to the outer portion by using different solvents, the density difference between the active material layers of the wound anode was maintained small, resulting in improved cycle life properties.

In Examples 3 to 7, where the active material layers on both surfaces of the anode current collector were each formed as two layers, both energy density and cycle life properties were improved.

In Example 3, where the density difference between the active material layers of the preliminary anode was maintained at a constant level, both energy density and cycle life properties were improved.

In Examples 4 and 7, where the active material density difference between the lower first active material layer and the upper first active material layer was 0.07 g/cm³ or more, the cycle life properties were slightly reduced.

In Comparative Examples where the active material density difference between the lower first active material layer and the upper first active material layer exceeded 0.1 g/cm³, the cycle life properties were reduced.

1. A method for manufacturing an electrode assembly for a secondary battery, comprising:
preparing an electrode current collector;
forming an upper active material layer on an upper surface of the electrode current collector and forming a lower active material layer having a lower density than the upper active material layer on a lower surface of the electrode current collector to form a preliminary electrode; and
winding the preliminary electrode with the lower active material layer disposed on an inner side of the winding to form a wound electrode including an upper wound active material layer and a lower wound active material layer.

2. The method for manufacturing an electrode assembly for a secondary battery according to claim 1, wherein the density of the upper wound active material layer is lower than the density of the upper active material layer, and the density of the lower wound active material layer is greater than the density of the lower active material layer.

3. The method for manufacturing an electrode assembly for a secondary battery according to claim 1, wherein the density difference between the upper wound active material layer and the lower wound active material layer is lower than the density difference between the upper active material layer and the lower active material layer.

4. The method for manufacturing an electrode assembly for a secondary battery according to claim 3, wherein the density difference between the upper wound active material layer and the lower wound active material layer is 0.1 g/cm³ or less.

5. The method for manufacturing an electrode assembly for a secondary battery according to claim 1, wherein forming the upper active material layer and the lower active material layer comprises coating an upper slurry and a lower slurry including a solvent and an active material, respectively, on the upper surface and the lower surface of the electrode current collector, and
wherein the solvent used in the upper slurry is different from the solvent used in the lower slurry.

6. The method for manufacturing an electrode assembly for a secondary battery according to claim 1, wherein the step of forming the preliminary electrode comprises forming at least one of the upper active material layer and the lower active material layer in a multi-layer structure having different densities.

7. The method for manufacturing an electrode assembly for a secondary battery according to claim 6, wherein forming the multi-layer structure comprises:
forming a first active material layer on a surface of the electrode current collector; and
forming a second active material layer on the first active material layer, the second active material layer being spaced apart from the electrode current collector with the first active material layer interposed therebetween, and having a different density from the first active material layer.

8. The method for manufacturing an electrode assembly for a secondary battery according to claim 7, wherein forming the first active material layer comprises applying a first slurry including a first solvent and a first active material, and
wherein forming the second active material layer comprises applying a second slurry including a second solvent different from the first solvent and a second active material to the first active material layer.

9. The method for manufacturing an electrode assembly for a secondary battery according to claim 8, wherein the second solvent comprises a solvent that is immiscible with the first solvent.

10. The method for manufacturing an electrode assembly for a secondary battery according to claim 8, wherein the upper active material layer comprises the first active material layer and the second active material layer, and
wherein the density of the second active material layer is greater than the density of the first active material layer.

11. The method for manufacturing an electrode assembly for a secondary battery according to claim 8, wherein the lower active material layer comprises the first active material layer and the second active material layer, and
wherein the density of the first active material layer is greater than the density of the second active material layer.

12. The method for manufacturing an electrode assembly for a secondary battery according to claim 8, wherein the first active material and the second active material are the same active material.

13. The method for manufacturing an electrode assembly for a secondary battery according to claim 12, wherein the first solvent and the second solvent have different solubilities for the active material.

14. The method for manufacturing an electrode assembly for a secondary battery according to claim 1, further comprising arranging the preliminary electrodes on a first surface and a second surface opposite to each other of a separation membrane, respectively,
wherein the separation membrane is wound together with the preliminary electrode.

15. A method for manufacturing a secondary battery, comprising:
preparing the electrode assembly manufactured according to claim 1; and
accommodating the electrode assembly in a case.
